(19) United States
(12) Patent Application Publication
(10) Pub. No.: US 2011/0240059 A1
(43) Pub. Date: Oct. 6, 2011

(54) CLEANING APPARATUS AND METHOD

(75) Inventors: Yukio OZAKI, Kawasaki (JP); Michinao Nomura, Kawasaki (JP); Mitsuo Takeuchi, Kawasaki (JP); Toshinori Kasuga, Kawasaki (JP)

(73) Assignee: FUJITSU LIMITED, Kawasaki-shi (JP)

(21) Appl. No.: 13/073,328

(22) Filed: Mar. 28, 2011

(30) Foreign Application Priority Data
Mar. 30, 2010 (JP) 2010-79366

(51) Int. Cl. B08B 3/00

(52) U.S. Cl. 134/18; 134/56 R

(57) ABSTRACT

A cleaning apparatus includes a supply unit to supply at least an initial amount of cleaning solution to a specific portion of an object to be cleaned, an agitator to induce agitation in the cleaning solution supplied to the object, an oscillating unit to oscillate the agitator, a drive unit to move any one of the object and the agitator so as to change a clearance between the object and the agitator, a detection unit to detect impedance of the oscillator, and a control unit to control the clearance by controlling the drive unit based on the impedance.

### CROSS-REFERENCE TO RELATED APPLICATIONS

This application is based upon and claims the benefit of priority of the prior Japanese Patent Application No. 2010-79366, filed on Mar. 30, 2010, the entire contents of which are incorporated herein by reference.

### FIELD

The embodiment discussed herein is related to a cleaning apparatus and cleaning method.

### BACKGROUND

Japanese Patent Application Laid-open Publication No. 2001-129502 and Japanese Patent Application Laid-open Publication No. 11-70372 discuss techniques for partially cleaning an object by supplying a cleaning solution to a specific portion of the object to be cleaned. High frequency sound waves are generated within the cleaning solution, which induces cavitation within the cleaning solution, i.e., which agitates the cleaning solution. Such agitation facilitates fine albeit undesired particles becoming unstuck from the object such that the fine particles float in the cleaning solution. After that, the cleaning solution is recovered. The cleaning solution is supplied generally to the specific portion of the object, so that the object may be cleaned with a small amount of the cleaning solution.

### SUMMARY

According to an embodiment, a cleaning apparatus includes a supply unit to supply at least an initial amount of cleaning solution to a specific portion of an object to be cleaned, an agitator to induce agitation in the cleaning solution supplied to the object, an oscillating unit to oscillate the agitator, a drive unit to move at least one of the object and the agitator so as to change a clearance between the object and the agitator, a detection unit to detect impedance of the oscillator, and a control unit to control the clearance by controlling the drive unit based on the impedance.

The object and advantages of the invention will be realized and attained by at least the features, elements, and combinations particularly pointed out in the claims.

It is to be understood that both the foregoing general description and the following detailed description are exemplary and explanatory and are not restrictive of the invention, as claimed.

### BRIEF DESCRIPTION OF DRAWINGS

FIG. 1 illustrates a cleaning apparatus according to an embodiment;

FIGS. 2A to 2D illustrate a cleaning method where the cleaning apparatus according to the embodiment performs;

FIGS. 3A to 3E illustrate the cleaning method where the cleaning apparatus according to the embodiment performs;

FIGS. 4A to 4C illustrate rising of the surface of cleaning solution;

FIGS. 5A and 5B illustrate a relation between impedance and clearance, and a relation between impedance and an amount of the cleaning solution, respectively;

FIGS. 6A to 6C illustrate a change of impedance in the cleaning operation when clearance control between a horn and an object and addition control of cleaning solution are not performed;

FIG. 7 illustrates an example of the cleaning method where the cleaning apparatus according to the embodiment performs;

FIG. 8 illustrates an example of the cleaning method where the cleaning apparatus according to the embodiment performs;

FIGS. 9A and 9B illustrate a graph of a relation between high-frequency components of impedance and a reduced amount of clearance, and a graph of a relation between low-frequency components of impedance and an additional amount of the cleaning solution, respectively;

FIGS. 10A and 10B illustrate a graph of a relation between high-frequency components of impedance and clearance when clearance control between the horn and the object is performed, and a graph of a relation between low-frequency components of impedance and an additional amount of the cleaning solution when the addition control of the cleaning solution is performed, respectively.

### DESCRIPTION OF EMBODIMENT

When a contact area between a cleaning solution and an object to be cleaned is reduced in a cleaning operation, a portion of the cleaning solution may dry on the surface of the object. As a result, it is probable that fine particles are left on the portion where the cleaning solution dries.

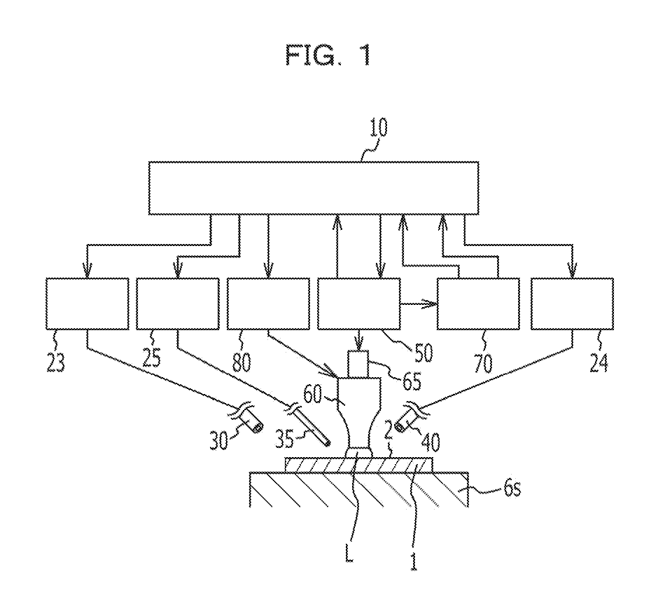

FIG. 1 illustrates the cleaning apparatus according to the embodiment. The cleaning apparatus according to the embodiment includes a control unit 10, a supply nozzle 30, an adding nozzle 35, a recovery nozzle 40, an oscillating unit 50, a horn 60, a detection and separation unit 70, and a lift 80. The control unit 10 controls the entire cleaning apparatus by sending commands to each part of the apparatus. The control unit 10 includes a central processing unit (CPU), a read only memory (ROM), and a random access memory (RAM) that are not illustrated. The control unit 10 may be a computer, for example.

The supply nozzle 30 supplies cleaning solution L to a specific portion of an object 1 that is a target to be cleaned. The control unit 10 drives a pump 23 coupled to the supply nozzle 30 and causes the supply nozzle 30 to supply the cleaning solution L.

The adding nozzle 35 supplies an additional amount of the cleaning solution L to the specific portion of the object 1. The control unit 10 drives a pump 25 coupled to the adding nozzle 35 and causes the adding nozzle 35 to supply the additional amount of the cleaning solution L. The diameter of a bore of the adding nozzle 35 is formed smaller than a bore of the supply nozzle 30. The diameter of the bore of the adding nozzle 35 may be about 100 μm, for example. The supply nozzle 30 and the adding nozzle 35 are coupled to a tank (not illustrated) that stores the cleaning solution L.

The recovery nozzle 40 draws and recovers the cleaning solution L on the object 1. The recovery nozzle 40 is coupled to a reduced pressure pump 24 for drawing the cleaning solution L. The recovery nozzle 40 is coupled to a drain tank (not illustrated) to store the recovered cleaning solution L.

An oscillator 65 includes a piezoelectric element that is deformed by having applied thereto a voltage. The oscillator 65 oscillates by the deforming of the piezoelectric element. The oscillator 65 is coupled to the horn 60 that amplifies the oscillation of the oscillator 65, so that ultrasonic waves are generated in the horn 60. The oscillating unit 50 applies a voltage to the piezoelectric element.

The horn 60 improves the coupling efficiency between the oscillating unit 50 and the cleaning solution L supplied to a surface 2 of the object 1. The horn 60 couples ultrasonic waves to the cleaning solution L. The horn 60 may be a known device. Together, the horn 60 and the oscillator 65 may be regarded as a type of agitator that agitates the cleaning solution L.

A detection and separation unit 70 detects impedance of the oscillating unit 50 based on voltages and currents generated by the oscillating unit 50 for generating the ultrasonic waves in the horn 60. For example, the detection and separation unit 70 detects impedance of the oscillating unit 50 based on the voltages and currents applied to the piezoelectric element. In addition, as described later, the detection and separation unit 70 includes a low-path filter and a high-path filter to separate impedance into low-frequency components and high-frequency components. The detection and separation unit 70 outputs the low-frequency components and the high-frequency components of the impedance to the control unit 10.

The lift 80 moves the horn 60 vertically. The lift 80 is driven in response to an instruction from the control unit 10. A clearance between the horn 60 and the object 1 is adjusted by the drive of the lift 80.

The object 1 that is a target to be cleaned is arranged at a stage 6s. The stage 6s is movable at least in an axial direction of the horn 60, that is, a vertical direction, and the movement is controlled based on an instruction from the control unit 10.

The cleaning solution may be water, for example. Alternatively, the cleaning solution may be detergent, organic solvent, or the like. The object 1 may be a lens, for example. Alternatively, the object 1 may be a semiconductor wafer, a printed board, a glass, a film, or the like. The cleaning apparatus according to the embodiment supplies the cleaning solution L on the specific portion of the surface 2 of the object 1, and cleans the object 1 partially, so that the object 1 may be cleaned with a small amount of the cleaning solution L. In addition, the cleaning apparatus according to the embodiment is suitable when an object, the entire of which may be generally hard to be cleaned, is desired to be partially cleaned.

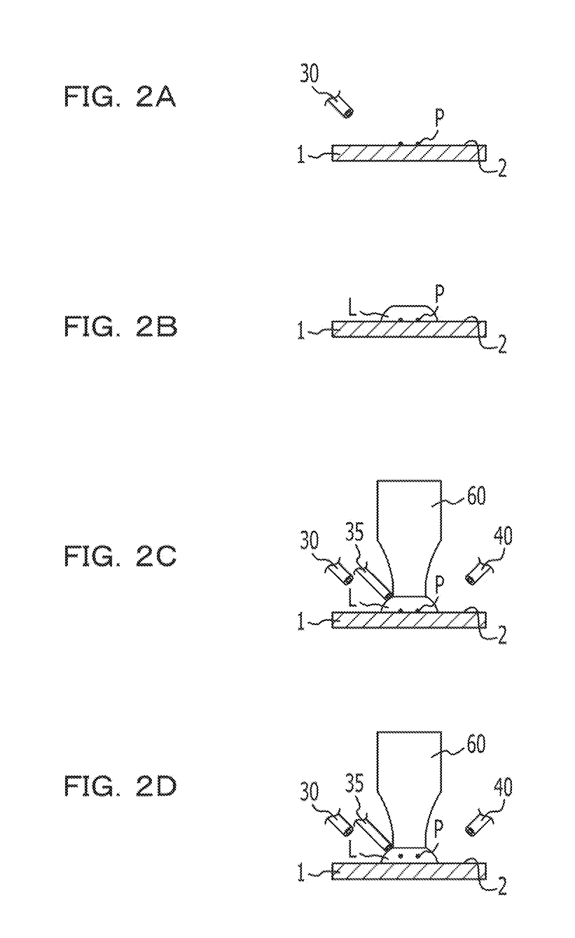

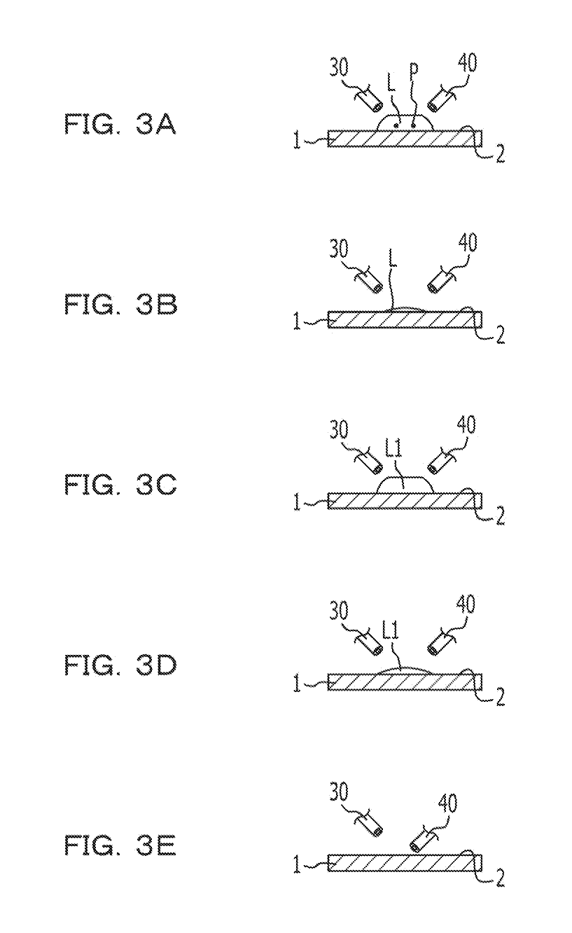

FIGS. 2A to 2D and 3A to 3E illustrate the cleaning method where the cleaning apparatus according to the embodiment performs. The stage 6s is omitted in the FIGS. 2A to 2D and 3A to 3E.

After the object 1 is arranged at the stage 6s, as illustrated in FIGS. 2A and 2B, the supply nozzle 30 moves toward the object 1 and the cleaning solution L is supplied to the specific portion of the surface 2 of the object 1. The supply nozzle 30 retracts from the object 1, as illustrated in FIG. 2C, the horn 60 comes into contact with the cleaning solution L, and the adding nozzle 35 is placed near the cleaning solution L. In such a state, when the oscillating unit 50 is driven and the ultrasonic waves are generated in the horn 60, fine particles P stuck to the surface 2 of the object 1 float in the cleaning solution L as illustrated in FIG. 2D. As described later, while the cleaning solution L is agitated, clearance control between the horn 60 and the object 1 and addition control of the cleaning solution L are performed.

When the cleaning solution L is agitated for a specific time period, the horn 60 is retracted from the object 1 as illustrated in FIG. 3A. The reduced pressure pump 24 is driven and the cleaning solution L is recovered by drawing through the recovery nozzle 40 as illustrated in FIG. 3B. As a result, the fine particles P floating in the cleaning solution L may be removed together with the cleaning solution L. In this case, a reduced or no amount of the cleaning solution L is left on the surface 2.

Rinsing solution L1 is supplied to the left cleaning solution L from the supply nozzle 30 as illustrated in FIG. 3C. The rinsing solution L1 is recovered through the recovery nozzle 40 as illustrated in FIG. 3D. After recovering the rinsing solution L1 through the recovery nozzle 40, the recovery nozzle 40 is placed near the surface 2, e.g., at about 0.2 mm and draws the left rinsing solution L1 as illustrated in FIG. 3E. The supply nozzle 30, the adding nozzle 35, the horn 60, and the like are retracted from the surface 2 of the object 1 and the cleaning operation of the object 1 ends.

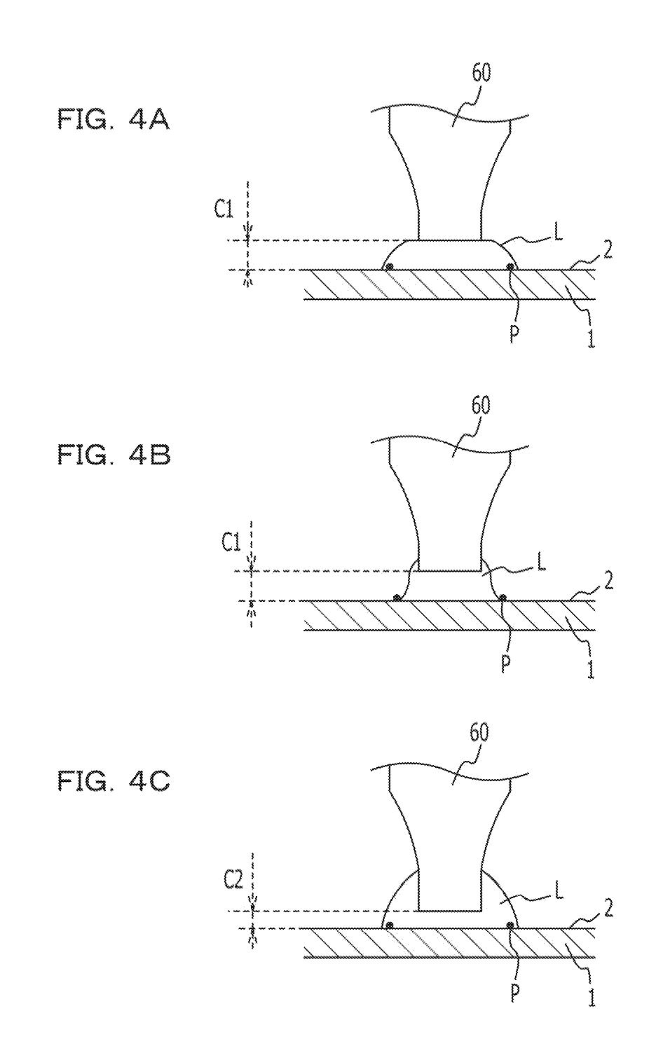

FIGS. 4A to 4C illustrate the rising of the surface of the cleaning solution L. FIG. 4A illustrates a state where a proximal end of the horn 60 comes into contact with the cleaning solution L before the ultrasonic waves are generated in the horn 60. Clearance between the proximal end of the horn 60 and the surface 2 of the object 1 may be C1 as illustrated in FIG. 4A. In this state, when the ultrasonic waves are generated in the horn 60, the cleaning solution L is agitated through the horn 60.

As illustrated in FIG. 4B, when the cleaning solution L is agitated through the horn 60, the rising of the surface of the cleaning solution L, that is, a phenomenon where the surface of the cleaning solution L rises up to the side surface beyond the proximal end of the horn 60 may be caused. Thus, the cleaning solution L that is below the proximal end of the horn 60 is reduced by the amount where the cleaning solution L rises up to the side surface beyond the proximal end of the horn 60. As a result, the contact area between the cleaning solution L and the surface 2 of the object 1 is reduced as illustrated in FIG. 4B. When the fine particles P are left in a portion where the contact area is reduced on the surface 2, it is probable that the fine particles P dry and stick on the surface 2 because the fine particles P are not covered with the cleaning solution L.

In the embodiment, the clearance between the object 1 and the horn 60 is adjusted so that the size of the contact area between the cleaning solution L and the surface 2 of the object 1 may be controlled to be kept even when such a rising of the surface of the cleaning solution L is caused. As illustrated in FIG. 4C, the lift 80 is driven and the horn 60 is moved. For example, the horn 60 is moved so that clearance C2 becomes smaller than the clearance C1 as illustrated in FIG. 4C. The horn 60 is placed near the object 1 as described above, so that the cleaning solution L that is pushed out by the horn 60 spreads in a side surface direction of the horn 60 and the contact area between the cleaning solution L and the surface 2 of the object 1 maybe return to the state illustrated in FIG. 4A. Thus, in the cleaning apparatus according to the embodiment the size of the contact area between the cleaning solution L and the surface 2 of the object 1 may be kept by controlling the clearance between the horn 60 and the object 1.

When the cleaning solution L is subjected to the ultrasonic waves for a specific time period, the cleaning solution L is highly heated, some of the cleaning solution L is atomized, and some of the atomized cleaning solution is evaporated. In addition, even when the cleaning solution L is not subjected to the ultrasonic waves, it is probable that some of the cleaning solution L may be evaporated. Thus, the amount of the cleaning solution L is reduced and the contact area between the cleaning solution L and the object 1 is also reduced. As a result, a portion of the cleaning solution L dries on the surface 2 and it is probable that the fine particles P are left on the portion where the cleaning solution L dries. In the cleaning apparatus according to the embodiment, in the cleaning operation, the size of the contact area between the cleaning solution L and the object 1 may be kept by supplying an additional amount of the cleaning solution L to the specific portion of the object 1.

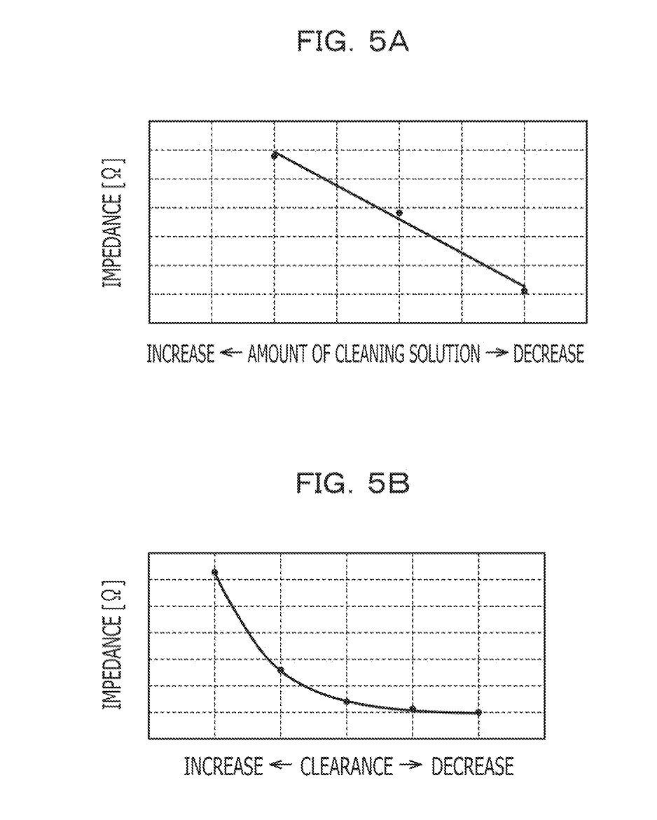

FIG. 5A illustrates the relation of impedance and the clearance between the horn 60 and the surface 2 of the object 1. FIG. 5A is a graph of the relation when the amount of the cleaning solution L is kept substantially constant.

As illustrated in FIG. 5A, when the amount of the cleaning solution L is kept substantially constant, as the clearance decreases, impedance increases. For example, the impedance is measured as a synthetic load of the horn 60, the cleaning solution L, and the object 1 that is the target to be cleaned. When the volume of the cleaning solution L is kept substantially constant and the clearance decreases, the size of the contact area between the cleaning solution L and the object 1 increases. The increase in the size of the contact area causes the load where the cleaning solution L receives from the object 1 to increase, so that the impedance increases.

FIG. 5B illustrates a graph of the relation of impedance and the amount of the cleaning solution L. FIG. 5B illustrates a graph of the relation when the clearance between the horn 60 and the surface 2 of the object 1 is kept substantially constant. As illustrated in FIG. 5B, when the clearance is kept substantially constant, as the amount of the cleaning solution L increases, the impedance increases. Because the amount of the cleaning solution L increases, the size of the contact area between the cleaning solution L and the object 1 increases. That is, as the amount of the cleaning solution L increases, the impedance decreases.

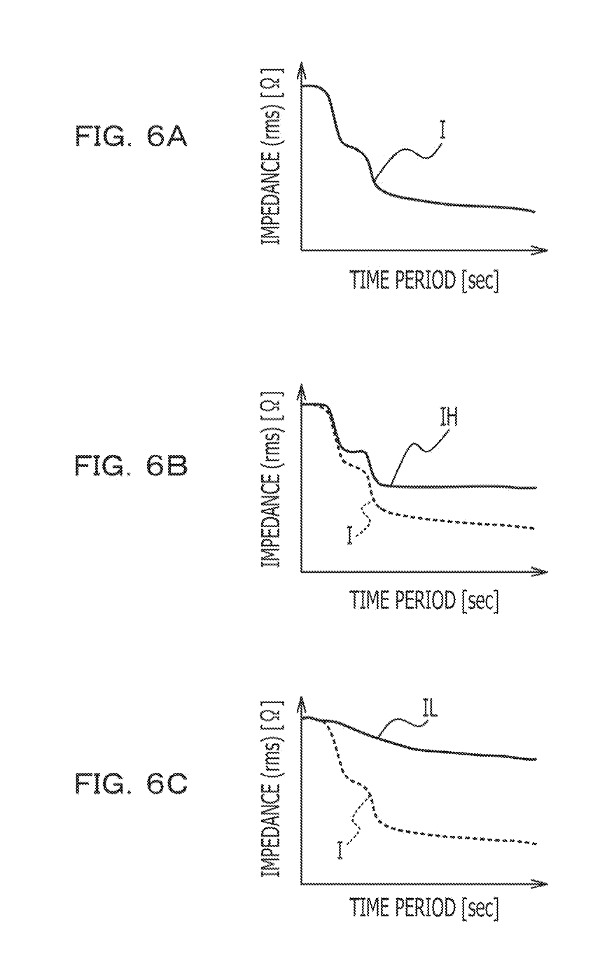

FIGS. 6A to 6C illustrate the change of impedance when neither the clearance control nor the addition control is performed. FIG. 6A illustrates the change of impedance. FIG. 6B illustrates high-frequency components of impedance in FIG. 6A. In FIG. 6B, the high-frequency components of the impedance are illustrated by curve IH. FIG. 6C illustrates low-frequency components of impedance in FIG. 6A. In FIG. 6C, the low-frequency components of the impedance are illustrated by curve IL. In FIGS. 6A to 6C, the impedance is illustrated by curve I. The separation of the impedance into the high-frequency components and low-frequency components is performed by the detection and separation unit 70.

The decrease in the high-frequency components of the impedance illustrated in FIG. 6B may be caused by the rising of the surface of the cleaning solution L because the surface of the cleaning solution L rises up to the side surface of the horn 60 for a short time period and the size of the contact area between the cleaning solution L and the object 1 decreases for a short time period. On the other hand, the decrease in the low-frequency components of the impedance illustrated in FIG. 6C may be caused by the reduction in the amount of the cleaning solution L due to the evaporation, or the like. When the amount of the cleaning solution L is gradually reduced, the size of the contact area between the cleaning solution L and the object 1 is gradually reduced. Whether the reduction in the size of the contact area between the cleaning solution L and the object 1 is caused by the rising of the surface of the cleaning solution L or the reduction in the amount of the cleaning solution L may be determined by the separation of the impedance into the high-frequency components and low-frequency components.

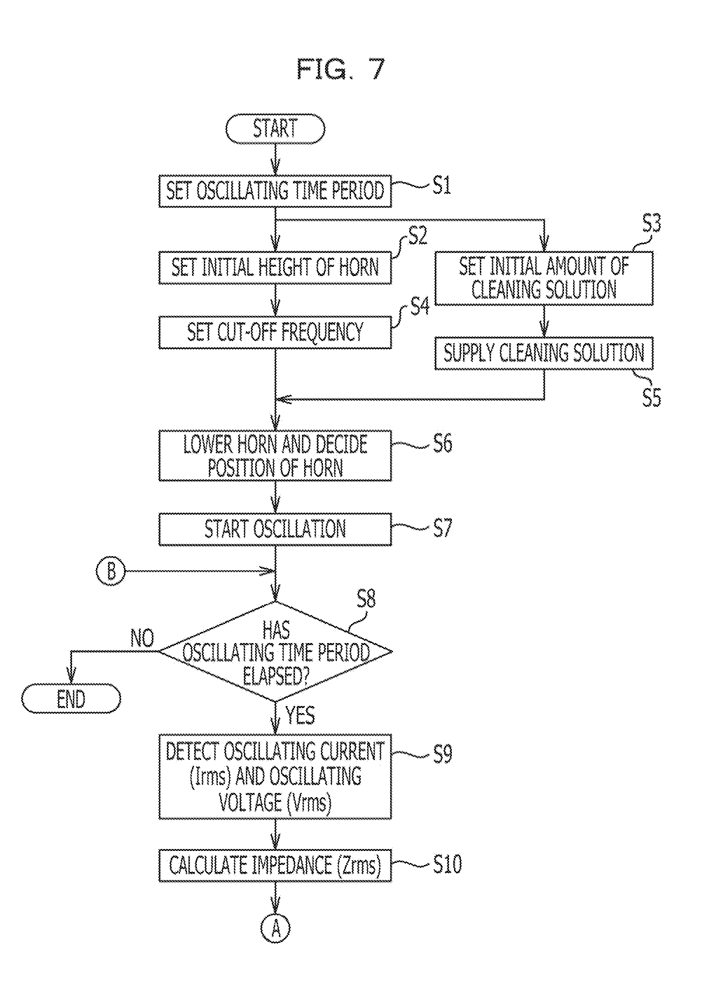

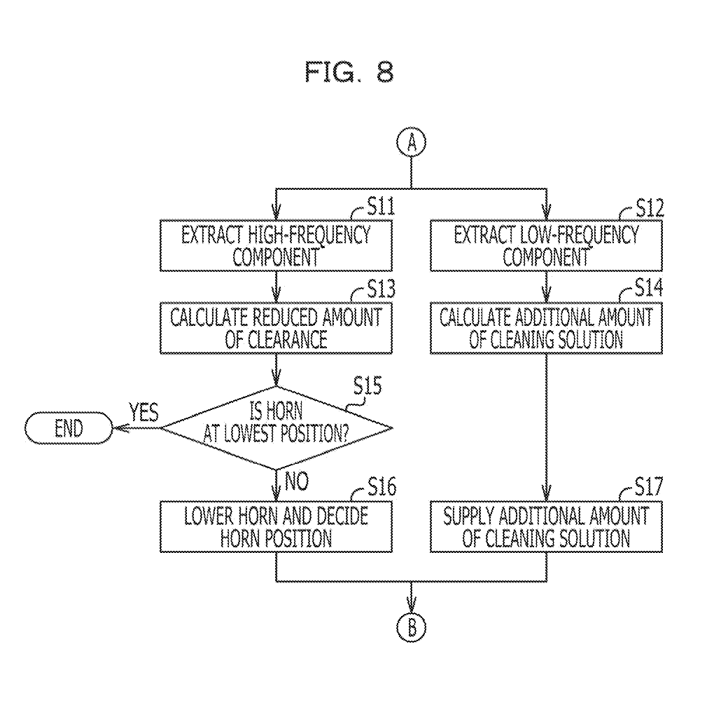

FIGS. 7 and 8 illustrate a flowchart of an example of the cleaning method where the cleaning apparatus according to the embodiment performs. First, an oscillating time period in the oscillating unit 50, an initial amount of the cleaning solution L, an initial height of the horn 60, and a cut-off frequency are set (Operations S1 to S4). A “cut-off frequency” is a frequency that is used for the separation of impedance into high-frequency components and low-frequency components detected by the detection and separation unit 70. The cleaning solution L is supplied to the specific portion of the object 1 (Operation S5). The horn 60 lowers using the lift 80 and the position of the horn 60 is decided (Operation S6).

Oscillation of high-frequency is started when the control unit 10 sends instructions to the oscillating unit 50 (Operation S7), so that the cleaning solution L is subjected to the ultrasonic waves generated in the horn 60 and the cleaning operation starts. The control unit 10 determines whether or not the oscillating time period set in Operation S1 has elapsed (Operation S8). When the oscillating time period has elapsed, the control unit 10 ends the processing.

The detection and separation unit 70 detects an oscillating current (Irms) and an oscillating voltage (Vrms) from the oscillating unit 50 (Operation S9), calculates impedance (Zrms) (Operation S10). The detection and separation unit 70 extracts the high-frequency components and low-frequency components of the impedance based on the cut-off frequency (Operation S11 and S12). The control unit 10 calculates a reduced amount of the clearance between the object 1 and the horn 60 based on the high-frequency components (Operation S13), and calculates an additional amount of cleaning solution L based on the low-frequency components (Operation S14).

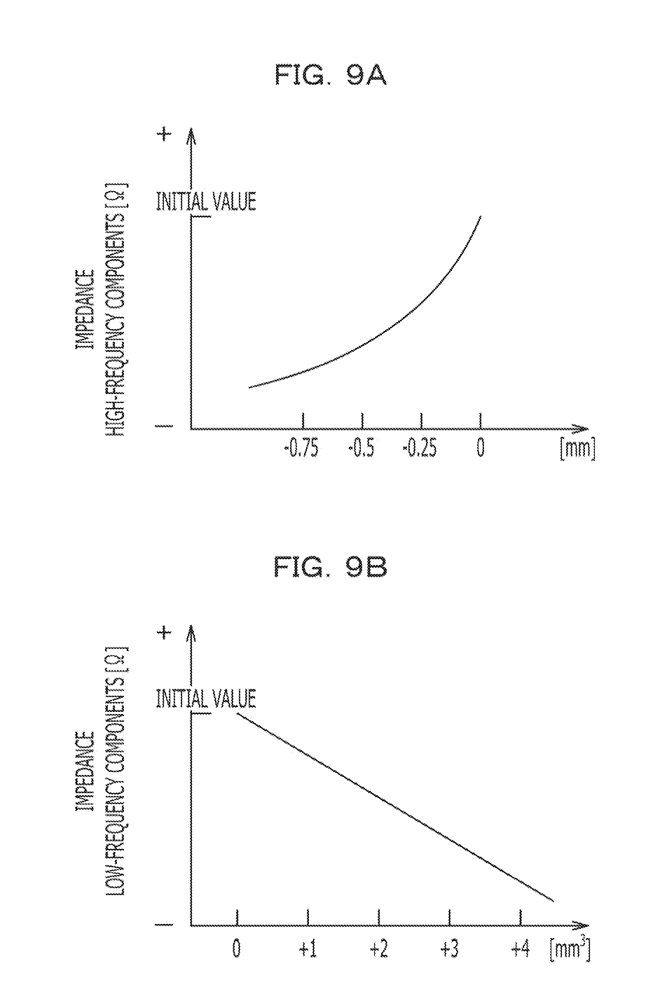

FIG. 9A illustrates a graph of a relation between high-frequency components of impedance and a reduced amount of the clearance. For example, the graph may be stored in the ROM of the control unit 10. The control unit 10 calculates the reduced amount of the clearance with reference to the graph. The vertical axis is based on an initial value of the high-frequency component at a start time of the cleaning operation. As illustrated in FIG. 9A, when the high-frequency components of the impedance are the initial value, the reduced amount of the clearance may be 0 (mm). That is, when the high-frequency components of the impedance are kept substantially constant, the clearance may keep the initial value. The clearance between the object 1 and the horn 60 decreases based on the reduced amount of the high-frequency component in the impedance caused by the amount in the rise of the cleaning solution L.

FIG. 9B illustrates a graph of a relation between low-frequency components of impedance and an additional amount of the cleaning solution L. For example, the graph may be stored in the ROM of the control unit 10. The control unit 10 calculates the additional amount of the cleaning solution L with reference to the graph. The vertical axis is based on an initial value of the low-frequency component at a start time of the cleaning operation. As illustrated in FIG. 9B, when the low-frequency components of the impedance is the initial value, the additional amount of the cleaning solution L may be 0 (mm³). That is, when the low-frequency components of the impedance are kept substatially constant, the additional amount of cleaning solution L is not supplied.

When the horn 60 lowers based on the calculated reduced amount of the clearance, the control unit 10 determines whether or not the horn 60 reaches the lowest position (Operation S15). When the horn 60 reaches the lowest position, the control unit 10 ends the processing.

When the horn 60 does not reach the lowest position, based on the calculated reduced amount of the clearance, the horn 60 lowers and a position of the horn 60 is decided (Operation S16). Thus, when the clearance decreases in a state where high-frequency component of the impedance decreases as described above, the horn 60 may go up to return to the initial position because the size of the contact area between the cleaning solution L and the object 1 increases.

After that, the control unit 10 supplies the calculated additional amount of cleaning solution L to the specific portion of the object 1 (Operation S17). As described above, each time the decrease in the low-frequency component of the impedance is detected, the additional amount of the cleaning solution L is supplied to the specific portion of the object 1. The additional amount of the cleaning solution L is supplied using the adding nozzle 35, however, the embodiment is not limited to the adding nozzle 35, and the supply nozzle 30 may be used as the adding nozzle 35 as well.

The processing in Operation S8 and the operations after Operation S8 are performed again. As described above, in the cleaning operation, the high-frequency components and low-frequency components of the impedance are detected, and the clearance control and the addition control are performed based on the detected components. The control unit 10 performs the processing in Operation S11, S13, S15, and S16 in parallel with the processing in Operation S12, S14, and S17. As a result, even when a certain time period is desired for the processing in each of the operations, the clearance control and the addition control may be substantially simultaneously performed. The control unit 10 may perform the processing in Operation S11 to S17 in series.

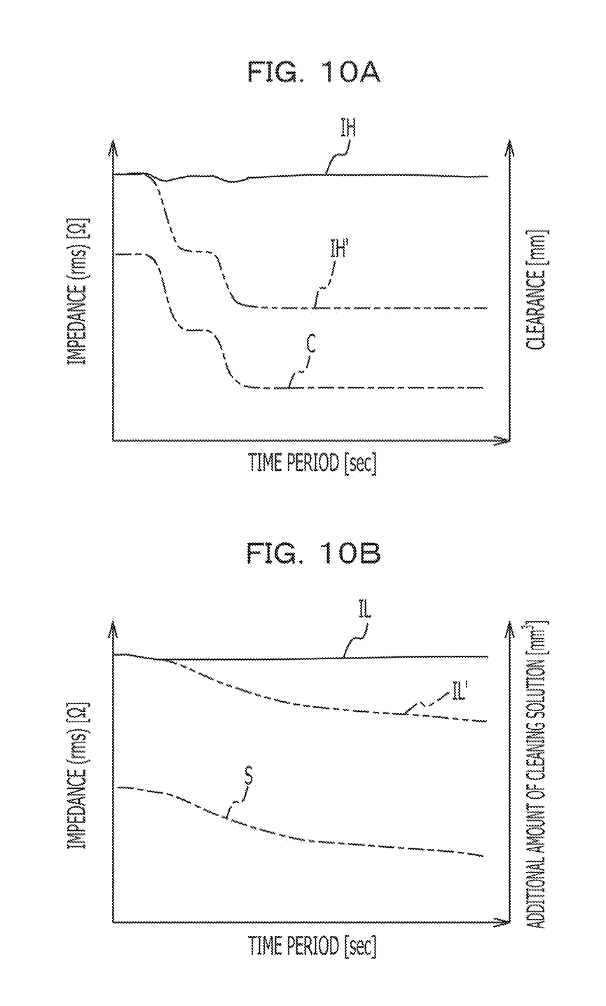

FIG. 10A illustrates a graph of a relation between high-frequency components of impedance and clearance between the horn 60 and the object 1 when the above-described clearance control is performed. The high-frequency components of the impedance when the above-described clearance control is performed are illustrated by a curve IH. In addition, the clearance when the above-described clearance control is performed is illustrated by a curve C. The clearance may be controlled so that the high-frequency components of the impedance are kept substantially constant. As a result, the size of the contact area between the cleaning solution L and the object 1 may be kept substantially constant. In FIG. 10A, the high-frequency components of the impedance when the clearance control is not performed are illustrated by a curve IH′.

FIG. 10B illustrates a graph of a relation between low-frequency components of impedance and an additional amount of the cleaning solution L when the above-described addition control is performed. The low-frequency components of the impedance when the above-described addition control is performed are illustrated by a curve IL. In addition, the additional amount of the cleaning solution L when the above-described addition control is performed is illustrated by a curve S. The additional amount of the cleaning solution L is supplied to the specific portion of the object 1 so that the low-frequency components of the impedance are kept substantially constant. As a result, the size of the contact area between the cleaning solution L and the object 1 may be kept substantially constant. In FIG. 10B, the low-frequency components of the impedance when the addition control is not performed are illustrated by a curve IL′.

A feedback control of the clearance may be performed so that the high-frequency components of the impedance are kept substantially constant. A feedback control of the additional amount of the cleaning solution L may be performed so that the low-frequency components of the impedance are kept substantially constant.

Although one preferred embodiment of the present invention has been described in detail above, the present invention is not limited to the above-described embodiment, and the present invention may be achieved by various modifications and alteration to the above-described embodiment within the scope of the present invention according to the claims.

Alternatively, the clearance control may be performed by moving the stage 6s arranged with the object 1 vertically. In the cleaning operation, one of the clearance control and the addition control may be performed. In the clearance control, the embodiment is not limited to the control operation where the size of the contact area between the cleaning solution L and the object 1 is always kept substantially constant as long as the clearance is merely controlled based on the impedance of the oscillating unit 50. In the addition control, the embodiment is not limited to the control operation where the size of the contact area between the cleaning solution L and the object 1 is always kept substantially constant as long as the additional amount of the cleaning solution L is supplied based on the impedance of the oscillating unit 50.

All examples and conditional language recited herein are intended for pedagogical purposes to aid the reader in understanding the aspects of the invention and the concepts contributed by the inventor to furthering the art, and are to be construed as being without limitation to such specifically recited examples and conditions. Although the embodiment in accordance with aspects of the present invention has been described in detail, it should be understood that various changes, substitutions, and alterations could be made hereto without departing from the spirit and scope of the invention.

Moreover, the term “or” is intended to mean an inclusive “or” rather than an exclusive “or”. That is, unless specified otherwise, or clear from the context, the phrase “X employs A or B” is intended to mean any of the natural inclusive permutations. That is, the phrase “X employs A or B” is satisfied by any of the following instances: X employs A; X employs B; or X employs both A and B. In addition, the articles “a” and “an” as used in this application and the appended claims should generally be construed to mean “one or more” unless specified otherwise or clear from the context to be directed to a singular form.

What is claimed is:

1. A cleaning apparatus comprising:
a supply unit to supply at least an initial amount of cleaning solution to a specific portion of an object to be cleaned;
an agitator to induce agitation in the cleaning solution supplied to the object;
an oscillating unit to oscillate the agitator;
a drive unit to move any one of the object and the agitator so as to change a clearance between the object and the agitator;
a detection unit to detect impedance of the oscillator; and
a control unit to control the clearance by controlling the drive unit based on the impedance.

2. The cleaning apparatus according to claim 1, wherein
the control unit controls the clearance so that the impedance is kept substantially constant.

3. The cleaning apparatus according to claim 1, wherein
the control unit causes the clearance to decrease when the impedance decreases.

4. The cleaning apparatus according to claim 1, wherein
the control unit controls the clearance based on high-frequency components of the impedance.

5. The cleaning apparatus according to claim 1, wherein
the control unit supplies an additional amount of the cleaning solution to the specific portion of the object based on the impedance.

6. The cleaning apparatus according to claim 1, wherein
the control unit supplies an additional amount of the cleaning solution to the specific portion of the object so that the impedance is kept substantially constant.

7. The cleaning apparatus according to claim 5, wherein
the control unit supplies the additional amount of the cleaning solution to the specific portion of the object when the impedance decreases.

8. The cleaning apparatus according to claim 5, wherein
the control unit supplies the additional amount of the cleaning solution to the specific portion of the object based on low-frequency components of the impedance.

9. A cleaning method comprising:
supplying at least an initial amount of cleaning solution to a specific portion of an object to be cleaned;
inducing agitation in the cleaning solution supplied to the object;
detecting an impedance of the oscillator; and
controlling the clearance by controlling the drive unit based on the impedance.
